(19) United States
(12) Patent Application Publication
(10) Pub. No.: US 2016/0360598 A1
(43) Pub. Date: Dec. 8, 2016

(54) LIGHTING SYSTEM WITH WIRELESS CONNECTIVITY FOR DECORATIVE AND OTHER APPLICATION

(71) Applicant: Emmanuel Menilik Negatu, Belcamp, MD (US)

(72) Inventor: Emmanuel Menilik Negatu, Belcamp, MD (US)

(21) Appl. No.: 15/174,313

(22) Filed: Jun. 6, 2016

Related U.S. Application Data
(60) Provisional application No. 62/170,939, filed on Jun. 4, 2015.

(51) Int. Cl. H05B 37/02; F21V 33/00; H05B 33/08; F21V 31/00; F21V 23/02; F21V 23/00

(52) U.S. Cl. CPC H05B 37/0272; F21V 23/023; F21V 23/008; H05B 33/0842; F21V 31/00; F21V 33/0012; F21W 2121/00

(57) ABSTRACT

A decorative lighting system comprising a furniture item having an installed lighting unit, the lighting unit comprising a light source; a wireless communication module connected with the light source, the wireless communication module configured to wirelessly connect in an ad hoc manner with one or more wireless communication devices; a power supply connected with the light source and the wireless communication module, and an enclosure for holding the light source, the wireless communication module, and the power supply.

### BACKGROUND

Decorative centerpieces are used for different occasions. In some instances, centerpieces include multicolor LEDs. The decorative centerpieces provide color and other aesthetic touches to the tables on which the centerpieces are placed in addition to the room in which the centerpieces are located.

### DESCRIPTION OF THE DRAWINGS

Aspects of the present disclosure are understood from the following detailed description and when read with the accompanying figures which form a part of the present application. It is noted that, in accordance with the standard practice in the industry, various features are not drawn to scale. In fact, the dimensions of the various features may be arbitrarily increased or reduced for clarity of discussion. One or more embodiments are illustrated by way of example, and not by limitation, in the figures of the accompanying drawings, wherein elements having the same reference numeral designations represent like elements throughout and wherein:

FIG. 1 is a high level functional diagram of a lighting system according to an embodiment;

FIG. 2 is a diagram of a chair with a decorative light unit according to an embodiment;

FIG. 3 is a diagram of a table with a decorative lighting unit according to an embodiment;

FIG. 4 is a diagram of a centerpiece with a decorative lighting unit according to an embodiment;

FIG. 5 is a functional block diagram of a decorative lighting unit according to an embodiment; and

FIG. 6 is a functional block diagram of a decorative lighting unit according to another embodiment.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

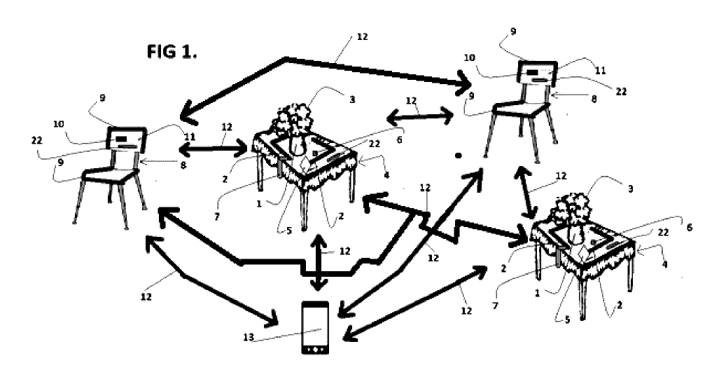

FIG. 1 is a high level functional diagram of a lighting system according to an embodiment. FIG. 1 includes a top system level view of tables and chairs with a centerpiece or decorative display (e.g., a vase 1) with removable or fixed LED units that are configured to communicate with each other while also being configured to be controlled by a smart device. An exemplary centerpiece decoration vase 1 is shown with artificial or natural ornament 3 (e.g., flowers) and placed on top of an exemplary table 4. LED units 2 are embedded or fixed in the exemplary table 4. In at least some embodiments, LED units 2 comprise one or more batteries as a power source. In at least some embodiments, LED units 2 comprise a conducting wire pair for connection to an electrical source or mains.

For purposes of illustration and not to be limiting, the following description will make reference to the table 4 and chair 8 of a generally rectangular shape. However, it will be appreciated that embodiments of the present disclosure are equally applicable to tables and chairs that have different shapes and sizes such as round or other shapes and long or short tables that are available. Additionally, one or more embodiments include other pieces of furniture and/or decoration, for example, chests, stages, lamps, stools, bookcases, wall decor, fence posts, walkways, railings, and similar items.

In some embodiments, an induction charging point pad 5 is used to place a charging battery on top of the table to charge batteries used by the embedded or fixed LED units 2. The LED unit batteries of each table are also removable through a slot 6 for recharging or replacement, in at least some embodiments. In some embodiments, the LED unit batteries of each table are non-removable. In some embodiments, the LED unit battery or batteries are chargeable through an electrical wire connection point 7. In some embodiments, the LED unit battery or batteries are chargeable through both of an induction charging point pad or an electrical wire connection point. Embodiments of the present disclosure are not limited to the specific shape of the charging pad 5, battery replacing slot 6 or electrical connection point 7.

The FIG. 1 lighting system comprises multiple components including vases 1, tables 4, chairs 8 and at least one mobile device 13. In at least some embodiments, mobile device 13 is a smart device such as a mobile telephone, a tablet, or similar device. Each of vases 1, tables 4, and chairs 8 includes a lighting unit, e.g., LED unit of FIG. 5.

Each lighting unit comprises a light source, a wireless communication module connected with the light source, and a power supply connected with the light source and the wireless communication module. Each lighting unit also comprises an enclosure to retain and protect the other components. The wireless communication module is configured to wirelessly connect in an ad hoc manner with one or more wireless communication devices. In at least some embodiments, the wireless communication devices include other wireless communication modules of other lighting units and other devices such as mobile device 13. As depicted, mobile device 13 is able to communicate wirelessly with one or more of lighting units in system components such as vases 1, tables 4, or chairs 8. Each of the system components is also configured to be able to communicate wirelessly with each other. In at least some embodiments, mobile device 13 is able to communicate with one of the lighting units of a system component in order to control the remaining lighting units of the system components. In at least some embodiments, the remaining lighting units are not within range of a wireless connection with mobile device 13. In at least some other embodiments, the remaining lighting units are within range of a wireless connection with mobile device 13. In at least some other embodiments, only some of the remaining lighting units are within range of a wireless connection with mobile device 13.

In at least some embodiments, communication between and/or among system components and/or mobile device 13 comprises at least one of control and/or data signals. In at least some embodiments, control signals cause one or more of the system components to control the emission of light from the light source and/or transmit the control signal(s) to one or more additional system components. In at least some embodiments, control signals and/or data signals cause one or more of the system components to control the amount, color, frequency, color shift, or other parameter of the light emitted by light source of the system component. In at least some embodiments, the adjustable light parameters also include color, speed of color change, timing of color change, syncing of color change with music and/or ambient sounds, color temperature, and color type. In at least some embodiments, control signals and/or data signals correspond to the parameter of the light emitted by the light source. In at least some embodiments, control signals and/or data signals correspond to a number of system components to which the control signal is to be transmitted. In at least some embodiments, control signals and/or data signals correspond to a timing of light emission and/or a repetition of light emission from the light source.

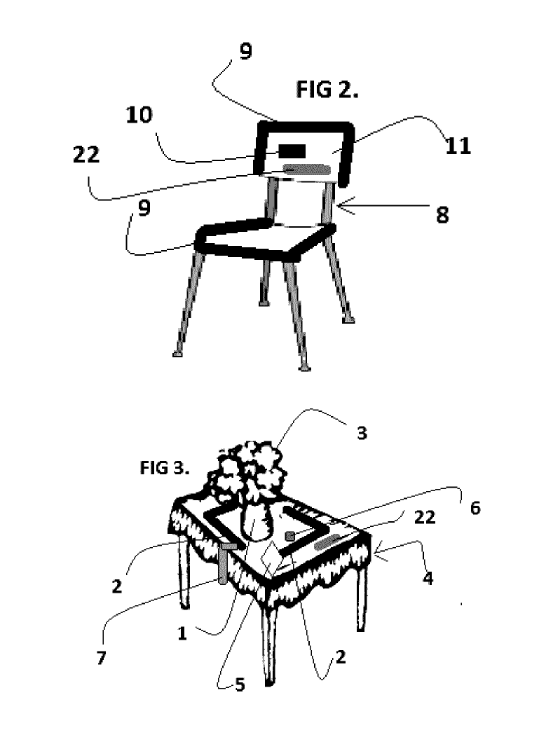

FIG. 2 is a diagram of a chair with a decorative light unit according to an embodiment. FIG. 2 includes a chair with embedded or removable LED units with rechargeable battery slots, charging points, and optional manual control slots. A typical fixed LED unit 9 is on a chair 8. The placement position of LED units 9 can take many shapes and configurations on the chair 8. The placement position of LED units 9 can take many shapes and configurations on table 4. The type of chair used is not limited to the exemplary chair 8. In some embodiments, the LED unit batteries are charged inductively using a charging pad at 10 or by replacing the rechargeable or non-rechargeable batteries through a slot 11. Embodiments of the present disclosure are not limited to the shape and placement of the charging pad 10 or the battery replacement slot(s). Chair 8 also comprises a control panel 22 for manually controlling operation of the light unit of chair 8. Control panel 22 enables manual control of LED units 9 on the chair. In at least some embodiments, control panel 22 enables manual control of one or more additional light units within wireless range of chair 8.

In FIG. 2, LED units 9 are arranged around a periphery of the seat back of chair 8 and are arranged around a periphery of the seat of chair 8. In at least some embodiments, LED units 9 are arranged around the entire periphery of the seat back and seat. In at least some embodiments, LED units 9 are arranged around three sides of the periphery of the seat back and seat of chair 8. In at least some embodiments, LED units 9 are arranged around solely the seat back of chair 8. In at least some embodiments, LED units 9 are arranged around solely the seat of chair 8. In at least some other embodiments, LED units 9 are arranged longitudinally within one or more legs of chair 8 and visible via one or more openings in the legs. In at least some other embodiments, LED units 9 are arranged along an exterior of one or more legs of chair 8.

FIG. 3 is a view showing a table with a decorative vase 1 containing centerpiece LED units sitting on top. The figure also shows a perspective view of embedded (fixed) centerpiece LED units on the table with battery charger and insertion ports and manual control option 22 port with overall communication scheme with surrounding centerpieces and LED units and a smart device indicated by arrows 12 as in FIG. 1.

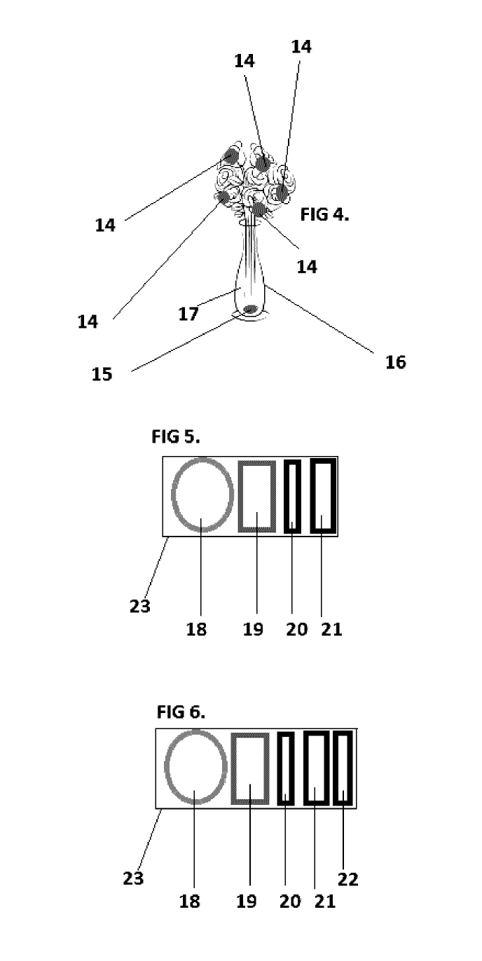

FIG. 4 is a diagram of a centerpiece with a decorative lighting unit according to an embodiment. FIG. 4 includes a centerpiece container usable as a container for embodiments of the present disclosure and which comprises submersible LED units 15 in a liquid 17 filled container 16 or free hanging or dangling LED units 14 on top of the container 16. Embodiments of the present disclosure are not limited to the shape of the container 16 and type of liquid 17. The number of free hanging LED units 14 and submersible LED units 15 is as many as the user desires. In at least some embodiments, a greater or lesser number of LED units 15 and/or 14 are used in conjunction with the centerpiece. In at least some embodiments, either one of LED units 15 or 14 are optional in conjunction with the centerpiece.

FIG. 5 is a functional block diagram of a decorative lighting unit according to an embodiment. FIG. 5 includes a view of components of an LED unit. The self-communicating and smart device controlled LED units generally indicated at 15, 14, 2, 9 in FIGS. 1, 2, 3, 4 includes a light source 18, e.g., red-green-blue (RGB) light emitting diodes (LEDs), a wireless communication module 19, e.g., Simblee RFD77101 BLE Module IC, a rechargeable or non-rechargeable battery 20, battery charging circuitry 21, and an enclosure 23. Embodiments of the present disclosure are not limited to the shape of enclosure 23. In some embodiments, a light source other than RGB LEDs is usable. For wireless communication of the LED units with the smart phone or tablet, the LED units will be configured to use Simblee Bluetooth communication protocol. In some embodiments, wireless communication of the LED units with the smart phone or tablet will be performed using other similar wireless protocols. The LED units will communicate with other LED units through the Simblee COMM, a bi-directional ad hoc communication protocol. In some embodiments, a wireless communication module other than Simblee RFD77101 BLE Module IC is usable. For example, in some embodiments, RF (e.g., ISM band RF), wife or 802.11 variant wireless networking protocol device is usable to provide ad hoc wireless networking between devices.

In at least one embodiment, light source 18 is electrically connected with wireless communication module 19 and battery 20. In such embodiment, battery 20 is electrically connected with charging circuitry 21. In at least some embodiments, battery 20 and charging circuitry 21 are replaced by an electrical connection to a power source or mains power supply.

FIG. 6 shows LED units that can be made to work with other ICs such as but not limited to RFD22102 (an RF-based wireless enabled microcontroller), RFD22301 (a Bluetooth-based wireless enabled microcontroller), and other ICs and discrete components. Embodiments of the present disclosure are not limited to the shape of enclosure 23. In FIG. 6, manual control panel 22 is part of the LED unit and electrically connected with at least wireless communication module 19.

One or more embodiments of the present disclosure relate generally to a centerpiece, table or chair top multicolor (e.g., RGB) LED system that has a plurality of decorative LED units that can be applied for a plurality of tables or chairs. In at least some embodiments, the LED system has an unlimited number of decorative LED units for an unlimited number of tables or chairs. The LED units can be activated and controlled wirelessly using smart devices such as phones, tablets and/or computers while the LED units are capable of communicating wirelessly with each other for coordinated and fast color switching among the various installed items.

More specifically, the centerpiece LED system consists of a plurality of RGB LED units affix able to a plurality of tables, chairs, or other similar items. Each LED unit in the system is removable (table top) or fixed permanently to the table or chair. The LED units can be water submersible or not. Each LED unit in the system can communicate with each other and with external smart devices and send data wirelessly using Bluetooth frequency or other radio frequency bands.

All LEDs under this system can be controlled by one or more smart devices using a software application (app) resident in each LED unit's (or selected LED unit's) integrated circuit (IC) hardware circuitry. The app is directly loaded to the smart device from the LED units wirelessly via a Bluetooth (or other) frequency communication when a smart device is in range (a range that can be specified during the setup of the LED unit, i.e., the range is a predetermined setting of the LED unit). When the smart device is outside the range, the app disappears from the device. In at least some embodiments, when the smart device is outside the range, the app is automatically uninstalled from the smart device. In at least some embodiments, when the smart device is outside the range, the app is automatically hidden from user access. In at least one embodiment, this task is accomplished using an IC chip called Simblee BLE Module RFD77101 that is embedded with each centerpiece LEDs circuitry. The multicolor LEDs used can be different brands that includes but not limited to WS2812, WS2812B, WS2811, SK6812RGBW and LRTBGFTM-ST7-1+VV9-29+Q5R, or other suitable LEDs. The LEDs circuitry also includes other electronics components such as voltage regulators, capacitors, resistors, and other ICs.

The main Simblee app can be downloaded onto the smart device from an app repository accessible via a network, e.g., an app store such as on an iOS or an Android operating system. The function of the main Simblee app is to serve as a browser or detector looking for Simblee-enabled lighting units or devices in the area, i.e., within the predetermined range of the units or devices. Thus, when a Simblee enabled device such as LED unit is in the area (nearby the smart device or within range), the main Simblee app lists all of these devices (names and functions) on the smart device. When the user selects the LED unit desired from the list, that selected Simblee enabled LED unit loads its controlling app to the smart device to enable the user to control the LED unit's lighting functions such as, color, brightness, sequence and timing. When the Simblee enabled LED lighting unit is out of range, the corresponding app and information disappears from the main controller app, e.g., a main Simblee app, listed items on the smart phone. The user connects with the first LED unit from the smart device through Bluetooth communication protocol. This LED unit in turn connects with other LED units in the area through an ad hoc communication protocol, e.g., Simblee COMM. Therefore, the user will be able to control and send data to other LED units through the first LED unit. Each LED unit also provides the capability to communicate to other LED units through a bi-directional ad hoc communication protocol, e.g., Simblee COMM.

In at least some embodiments, the main controller app functions just like a browser. Without the main controller app, LED units, i.e., Simblee enabled devices, in the area are not visible on the smart device. But if there are 2 enabled devices, e.g., LED units, the enabled devices will be listed in the browser. When a user selects the first enabled device (e.g., an LED unit), the app inside the enabled device (LED unit) is loaded to the smart phone, the app could be a color changing button, so the user can control the LED unit and its ad hoc connected LED units.

Returning to the main controller app, (Simblee main browser app) and selecting the second enabled device on the list (e.g., another LED unit or a motor controller), the second enabled device loads its own app to the smart device just like the first enabled device but the loaded app will be different since devices are different. For the second enabled device, the loaded app could be just two buttons for On/Off control of the motor.

In another embodiment, if there is a third enabled device (e.g., a Simblee enabled speaker) when the user selects that device in the main controller app, the app loaded to the phone could comprise a volume bar.

If there is no device listed in the main controller app, then the user can't click and choose anything, so nothing will be loaded to the phone/smart device. But the main browser app stays in the phone looking for enabled devices within range.

Each removable centerpiece LED on each table or chair will have its own electronics circuitry and rechargeable battery with induction plugged charging capability embedded. In at least some embodiments, the removable centerpiece LED is submersible to a depth of 6 feet. In at least some embodiments, the removable centerpiece LED is submersible to a depth of 30 feet. When these LEDs need to be charged, they flash a special sequence of lights predetermined by a programmer. The operator can remove the LED units from the tables or chairs and put them in a special electronics induction charging tray or trays for wireless induction charging of all LED units in groups or at once. In some embodiments, the LED units are made stackable making electrical connection with each other for charging purposes; thus, only one of them needs to be connected to a charger through an electric wire. In at least some embodiments, the LEDs are fit with non-rechargeable batteries to be replaced when needed.

In at least one embodiment, the centerpiece LED units that are permanently fixed with the tables or LED units fixed on chairs are not removable for charging as they are fixed. Therefore in such embodiment, each table or chair has a slot that holds a rechargeable battery integrated with inductive charging circuitry that is removable for placement on an inductive charging tray/trays for charging; all or group of the batteries at once for reuse. Another method is each table or chair has a slot for an inductive or plugged charger place holder (pad or plug) on it, a battery charger is placed on top and the system is charged wirelessly or via plugging into a mains power supply. The fixed LEDs on each table/chair can also be charged using electrical wire plugged to the table directly from a power strip or wall outlet at the end of an event or at night.

The LED units while communicating with each other or with a smart device, have a built in encryption engine security feature which allows only authorized users to access and control or change them. In at least some embodiments, the encryption engine is an AES encryption engine.

The depicted smart device 13 is a smart phone, tablet or a computer. The type, quantity (number of smart devices participating) and brand of the smart devices includes all smart devices that are capable of communicating with external devices using Bluetooth frequency or other RF bands. Interweaved or mesh communication capabilities of these centerpiece LED units and the controlling smart devices with each other is depicted by arrow 12. The number of LED units in a system is not limited to the exemplary number of chairs and tables depicted. However, the number of LED units can be as many as the user desired.

The LED units in each chair 9 or in each table 2 can be controlled as an option manually using buttons and touch sensors panel at 22. The shape of this control panel 22 and number of buttons or touch sensors that it can hold is not limited by this invention.

It will be readily seen by one of ordinary skill in the art that the disclosed embodiments fulfill one or more of the advantages set forth above. After reading the foregoing specification, one of ordinary skill will be able to affect various changes, substitutions of equivalents and various other embodiments as broadly disclosed herein. It is therefore intended that the protection granted hereon be limited only by the definition contained in the appended claims and equivalents thereof.

What is claimed is:

1. A decorative lighting system comprising:
a furniture item having an installed lighting unit, the lighting unit comprising:
a light source;
a wireless communication module connected with the light source, the wireless communication module configured to wirelessly connect in an ad hoc manner with one or more wireless communication devices;
a power supply connected with the light source and the wireless communication module, and
an enclosure for holding the light source, the wireless communication module, and the power supply.

2. The decorative lighting system of claim 1, wherein the furniture item is at least one of a table, a chair, a stage, a chest, a lamp, or a vase.

3. The decorative lighting system of claim 1, further comprising another furniture item having an installed lighting unit and configured to communicate with the lighting unit of the furniture item.

4. The decorative lighting system of claim 3, wherein the communication between the lighting units of the furniture items comprises status of the light source, color of the light source, brightness of the light source, or pattern of the light source.

5. The decorative lighting system of claim 1, wherein the lighting unit of the furniture item is configured to communicate with one or more wireless communication devices data and/or commands comprising status of the light source, color of the light source, brightness of the light source, or pattern of the light source.

6. The decorative lighting system of claim 1, wherein the wireless communication module is configured to communicate with a smart device.

7. The decorative lighting system of claim 6, wherein the wireless communication module communication comprises at least one of a control signal or a data signal for controlling operation of the light source.

8. The decorative lighting system of claim 3, wherein the wireless communication module of the furniture item and the wireless communication module of the other furniture item are configured to communicate and synchronize the light emitted by the light source of each of the furniture item and the other furniture item.

9. The decorative lighting system of claim 8, wherein the wireless communication modules of the furniture item and the other furniture item are configured to communicate and synchronize one or more of the color, pattern, or intensity of the light emitted by the light source of each of the furniture item and the other furniture item.

10. The decorative lighting system of claim 8, wherein the lighting unit is submersible.

11. A decorative multicolor (RGB) LED lighting system with more than one self-communicating, application software loaded and smart devices controlled, independently powered LED units integrated with Simblee™ BLE Module RFD77101.

12. The decorative multicolor LED lighting system of claim 11, wherein the LED units are configured to communicate with a smart device.

13. The decorative multicolor LED lighting system of claim 11, wherein the LED units are configured to communicate with each other.

14. The decorative multicolor LED lighting system of claim 11, wherein the LED unit is submersible.
